(19) United States
(12) Patent Application Publication
(10) Pub. No.: US 2011/0112720 A1
(43) Pub. Date: May 12, 2011

(54) Road Conditions Reporting

(76) Inventors: Dale Keep, Walla Walla, WA (US); Lance Doyle, Walla Walla, WA (US); Mark Swayne, Walla Walla, WA (US)

(21) Appl. No.: 12/651,285

(22) Filed: Dec. 31, 2009

Related U.S. Application Data
(60) Provisional application No. 61/259,628, filed on Nov. 9, 2009.

(51) Int. Cl. G06F 7/00

(52) U.S. Cl. 701/36; 340/500

(57) ABSTRACT

Road conditions reporting is described. In embodiments, road conditions data is received and a condition of a roadway can be determined based on the road conditions data. The road conditions data can be received from a roadside station, vehicles, and/or from one or more sensors. The road conditions data and/or the condition of the roadway can then be communicated to a road conditions data system. In various embodiments, a road conditions data system can be implemented in a vehicle, or a road conditions data system can be implemented as a roadside station.

### RELATED APPLICATION

This application claims the benefit of a related U.S. Provisional Application Ser. No. 61/259,628 filed Nov. 9, 2009 entitled “Road Conditions Reporting” to Keep et al., the disclosure of which is incorporated by reference herein in its entirety.

### BACKGROUND

Inclement weather conditions and other environmental factors can quickly change the surface conditions of a roadway and affect the safe operations of vehicles, particularly when the surface conditions are unknown or not apparent to an operator of a vehicle. Additionally, state, county, and municipal road crews attempt to mitigate unsafe travel conditions, such as when chemical solutions are applied on a road surface to thaw and/or break-up ice that has formed on the roadway, or in an effort to prevent the ice from forming. Motorists and road crews both rely on weather forecasts, visual indications, and experience to assess driving conditions, and to estimate when and where chemical solutions can be applied on a roadway to mitigate predicted unsafe travel conditions.

Conventionally, a safe driving advisory may be recorded and broadcast over an AM radio frequency to inform vehicle operators of travel conditions, such as road construction schedules or a general weather advisory. However, these recorded advisories are often general advisories for a region, are simply a recorded message on a repetitive loop, and are not updated as often or as quickly as travel conditions change.

### SUMMARY

This summary is provided to introduce concepts of road conditions reporting that are further described below in the Detailed Description. This summary is not intended to identify essential features of the claimed subject matter, nor is it intended for use in determining the scope of the claimed subject matter.

Road conditions reporting is described. In embodiments, road conditions data is received and a condition of a roadway is determined based on the road conditions data. The road conditions data can be received from a roadside station, vehicles, and/or from one or more sensors. The road conditions data and/or the condition of the roadway can then be communicated to a road conditions data system. The road conditions data can include, but is not limited to, sensor data, environmental data, weather forecast data, traffic data, and user input data. In various embodiments, a road conditions data system can be implemented in a vehicle, as a roadside station, or as a reporting sign. For example, a road conditions data system can include a display device that is implemented as a reporting sign to display the condition of the roadway and/or the road conditions data.

In an embodiment, a vehicle can include a road conditions data system that receives road conditions data, such as sensor data from sensors proximate a surface of the roadway, from a roadside station, and/or from additional vehicles. A condition of the roadway can be determined based on the road conditions data. The condition of the roadway and/or the road conditions data can then be communicated to another vehicle or roadside station. Alternatively or in addition, the condition of the roadway and/or the road conditions data can be displayed for viewing by an operator of the vehicle traveling on the roadway, such as on a display device that is integrated in the vehicle. For a vehicle that is implemented to apply a chemical solution onto the surface of the roadway, the road conditions data system can be implemented to calculate an application rate of the chemical solution based on the road conditions data, communicate the application rate as an input to a control system for application of the chemical solution, and/or track a quantity of the chemical solution that is applied on the roadway and where along the roadway the chemical solution is applied.

In other embodiments, sensor elements of a sensor device detect a road condition factor, such as a detectable environmental condition, and the road condition factor is maintained as road conditions data. An antenna of the sensor device receives an RF signal that is converted into stored energy, and at least some of the stored energy is utilized to communicate the road conditions data to a road conditions data system. In an embodiment, an additional antenna of the sensor device receives at least one additional RF signal that is converted into the stored energy, and components of the sensor device are powered by at least some of the stored energy. The RF signal that powers the sensor device can be received from the road conditions data system that is implemented in a vehicle. Alternatively or in addition, the RF signal that powers the sensor device can be received from the road conditions data system that is implemented as a roadside station, or as a reporting sign.

### BRIEF DESCRIPTION OF THE DRAWINGS

Embodiments of road conditions reporting are described with reference to the following drawings. The same numbers are used throughout the drawings to reference like features and components:

FIG. 1 illustrates an example environment in which embodiments of road conditions reporting can be implemented.

FIG. 2 illustrates an example sensor device in accordance with one or more embodiments.

FIG. 3 illustrates example method(s) of road conditions reporting in accordance with one or more embodiments, and is described with reference to a road conditions data system and/or service.

FIG. 4 illustrates example method(s) of road conditions reporting in accordance with one or more embodiments, and is described with reference to a road conditions data system and/or service.

FIG. 5 illustrates example method(s) of road conditions reporting in accordance with one or more embodiments, and is described with reference to a reporting sign.

FIG. 6 illustrates example method(s) of road conditions reporting in accordance with one or more embodiments, and is described with reference to a sensor device.

FIG. 7 illustrates various components of an example device that can implement embodiments of road conditions reporting.

### DETAILED DESCRIPTION

Embodiments of road conditions reporting provide real-time (or approximate real-time) reporting of road conditions, such as the surface conditions of a roadway that may affect the safe operation of a vehicle. For example, a vehicle traveling along a roadway can communicate road conditions data to another vehicle traveling in an opposite direction along the roadway. A condition of the roadway can be determined based on the road conditions data and a vehicle operator may be warned of an unsafe travel condition up ahead. An unsafe travel condition may include black ice on the surface of the roadway, inclement weather, road construction, a section of the roadway where travel is unusually slow, poor visibility, and any other type of road condition that may pose an unsafe travel condition.

Embodiments of road conditions reporting can be implemented to collect road conditions data, monitor and determine roadway conditions, and report the road conditions data via any combination of various communication links, such as vehicle to vehicle, roadside station to a vehicle, vehicle to a roadside station, vehicle to a data collection station, and/or roadside station to a data collection station. The road conditions data can include any type of data that may be utilized to determine a roadway condition, such as environmental data, sensor data, weather forecast data, traffic data, historical data, predicted data, and/or user input data.

In one example, embodiments of road conditions reporting automates at least part of the analysis that a vehicle operator might go through to determine a safe driving speed based on visual indications and past experiences when assessing driving conditions. However, unlike a vehicle operator, a road conditions data system utilizes better and real-time information to determine a roadway condition, such as the road surface temperature which may be several temperature degrees different than a current air temperature. Typical outdoor systems and temperature indicators in vehicles only indicate the current air temperature, rather than the roadway surface temperature. An air temperature of thirty-five degrees (35° Fahrenheit) may cause a vehicle operator to assume that a roadway surface is free of ice, when in-fact the roadway surface temperature may be at freezing or below thirty-two degrees (32° Fahrenheit), in which case ice may have formed on the surface of the roadway. This may affect the safe operation of a vehicle, particularly when there is little or no perceptible visual distinction to a vehicle operator between a wet road surface and black ice on the roadway.

While features and concepts of the described systems and methods for road conditions reporting can be implemented in any number of different environments, systems, and/or various configurations, embodiments of road conditions reporting are described in the context of the following example systems and environments.

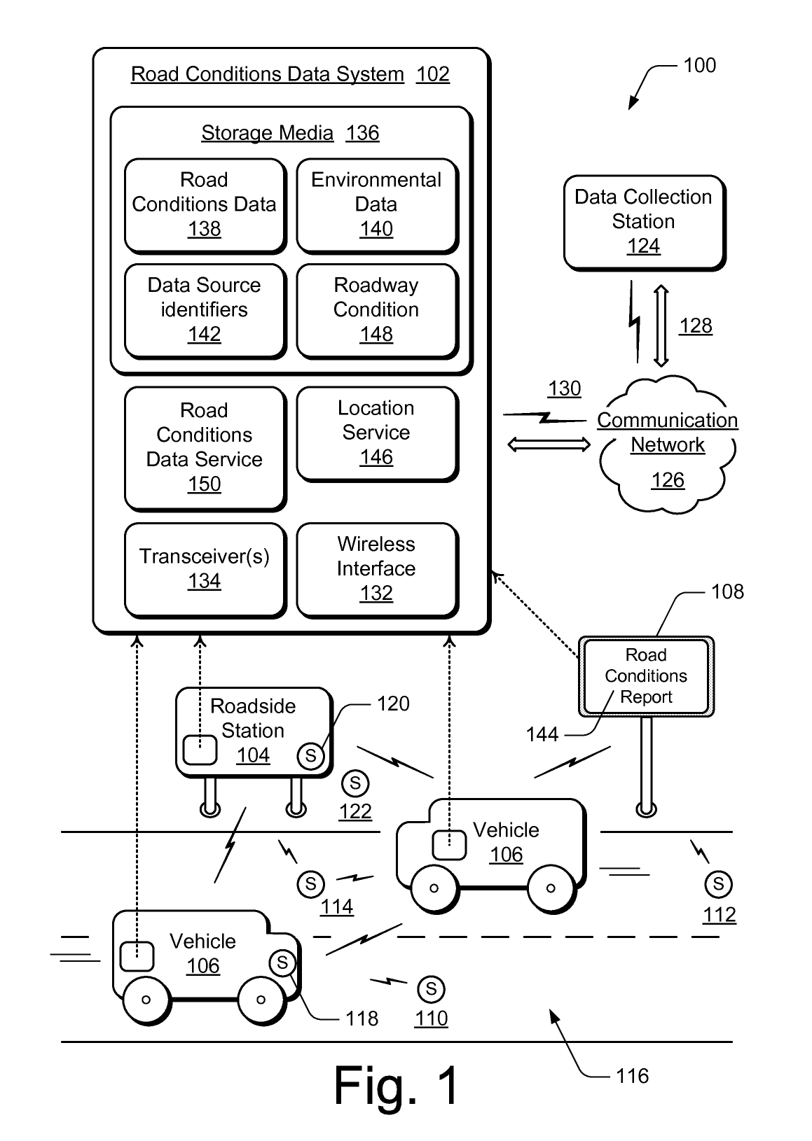

FIG. 1 illustrates an example environment 100 in which various embodiments of road conditions reporting can be implemented. In this example, environment 100 includes a road conditions data system 102 (also referred to as reader, or reader device) that can be implemented as a roadside station 104, in any type of vehicle 106, as a reporting sign 108 (e.g., also referred to as a smart sign), and/or as an independent system. Environment 100 also includes various sensors that sense or otherwise detect environmental and/or road conditions, and any of the various sensors may be referred to as an intelligent environmental sensor. The sensors may be installed in a roadway, in a vehicle, as part of a roadside station or proximate a roadside station, as part of a reporting sign or proximate a reporting sign, or anywhere in the environment 100 to detect the environmental and/or road conditions. For example, sensors 110, 112, and 114 are installed in roadway 116, sensor 118 is implemented in vehicle 106, sensor 120 is implemented as part of the roadside station 104, and sensor 122 is proximate the roadside station 104. Although only a few sensors, one roadside station, and one reporting sign is shown, any number of sensors, roadside stations, and reporting signs, as well as vehicles equipped with a road conditions data system 102, can be implemented in embodiments of road conditions reporting.

The road conditions data system 102 (e.g., implemented as a roadside station, a reporting sign, and/or in vehicles) facilitates communication of road conditions data between any of the various roadside stations, reporting signs, vehicles, and/or sensors. The data communication can be over one or more of several communication protocols, such as wired, wireless, fiber optic, WiFi, Bluetooth, in accordance with the IEEE 802.11p standard, and via other data communication protocols. A road conditions data system 102 can also be implemented to communicate road conditions data to a data collection station 124 via a communication network 126. The data collection station 124 may be implemented at a state, county, and/or municipal transportation department to collect the road conditions data, such as from roadside stations, transportation department vehicles, and/or other civic vehicles.

For example, a transportation department vehicle may be dispatched to apply a chemical solution on a roadway surface in an effort to mitigate an unsafe travel condition, such as to thaw ice that has formed on the surface of the roadway. A road conditions data system 102 implemented in the transportation department vehicle can collect road conditions data from various roadside stations and sensors, as well as from other vehicles, along the route that the transportation department vehicle travels. The road conditions data can be collected as any type of environmental data, sensor data, weather forecast data, traffic data, historical data, predicted data, and/or user input data.

In an embodiment, the road conditions data system in the transportation department vehicle can also be implemented to track how much of a chemical solution is applied to a roadway surface and where along the roadway the chemical solution was applied (e.g., between specific mileposts and/or tracked by GPS). Alternatively or in addition, the road conditions data system in a vehicle that disperses or applies a chemical solution (e.g., an anti-icing or de-icing chemical) onto a roadway surface can be implemented to calculate an application rate of the chemical solution based on the road conditions data. The application rate of the chemical solution can be calculated in real-time (or approximate real-time) and can be utilized as an input to a control system that controls the application of the chemical solution onto the roadway surface along the route that the transportation department vehicle travels. In practice, chemical solutions that are applied to a roadway surface to reduce the freeze point (e.g., prevent ice formation) include any one or combination of salt, magnesium chloride, calcium chloride, potassium acetate, potassium chloride, corrosion inhibitors, etc.

When the vehicle returns to the transportation department, the road conditions data and the chemical solution application data is communicated or otherwise downloaded to the data collection station 124 where it may be aggregated with other road conditions data collected from additional roadside stations and/or vehicles. For example, law enforcement vehicles may also be equipped with a road conditions data system 102 that collects road conditions data from the various roadside stations, sensors, and other vehicles along the route that a law enforcement vehicle travels.

The communication network 126 can be implemented to include an IP-based network 128 and/or a wireless network 130 that facilitates data communication between the data collection station 124 and the road conditions data system 102 (e.g., implemented as a roadside station and/or in vehicles). The communication network 126 can be implemented using any type of network topology and/or communication protocol, and can be represented or otherwise implemented as a combination of two or more networks. The communication network 126 can also include any number of communication nodes, such as wireless access points and/or cellular towers for wireless communication. The communication network 126 may also include a mobile operator network that is managed by a communication service provider, such as a wireless network provider and/or Internet service provider, to facilitate data communications for any type of a wired, wireless, and/or mobile device. In the example environment, the road conditions data system 102 includes a wireless interface 132 to facilitate wireless data communication between various roadside stations, vehicles, reporting signs, sensors, and data collection stations.

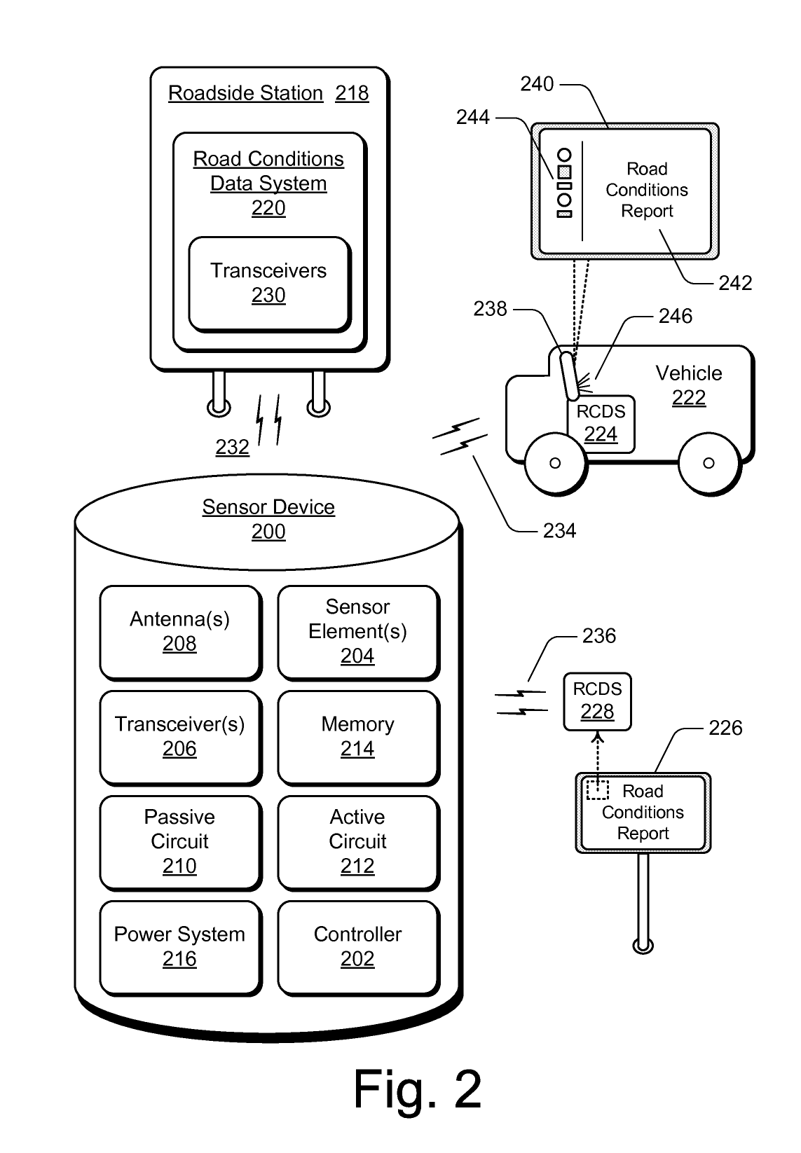

Any of the various sensors in example environment 100 can include one or more transceivers, corresponding sensor antennas (e.g., directional or omni-directional antennas), as well as one or more sensing elements. In addition, any of the sensors may be implemented with any number and combination of differing components as further described with reference to the example sensor device shown in FIG. 2. Any of the various sensors can be implemented as a passive, semi-passive, and/or an active sensor. A passive sensor, such as sensor 114 that is installed in roadway 116, can be powered from the field of an RF signal when a transceiver 134 (e.g., a transmitting device) of the road conditions data system 102 broadcasts a continuous wave pattern that charges the sensor. Radio frequencies that may be used include, but are not limited to, Low Frequency (LF), High Frequency (HF), and Ultra High Frequency (UHF), as well as microwave wavelengths. A sensor can be implemented to receive and convert the frequency energy into usable electrical energy.

For example, the roadside station 104, a vehicle 106 that is implemented with a road conditions data system 102, and/or the reporting sign 108 interrogates a sensor 114 while also providing power to the sensor to communicate back road conditions data. In an embodiment, the road conditions data system 102 includes multiple transceivers 134 to power the various sensors, such as to power a passive circuit of a sensor via one RF signal while data communication is facilitated by an active circuit of the sensor that is powered via a second RF signal. Additional transceivers 134 may also be implemented to power a passive or semi-passive sensor that includes corresponding antennas and circuitry to receive the different RF signals.

Power for a semi-passive sensor can be obtained passively as described above, and can also include power derived from a battery source, a wired power source, or alternative power sources such as solar, vibration, temperature differential, and/or wind or moving air (e.g., as a vehicle passes proximate a sensor and creates a wind effect). An active sensor can also be powered from a battery source, a wired power source, a vehicle power source, or by any of the alternative power sources.

The road conditions data system 102 includes storage media 136 to store or otherwise maintain various data, such as road conditions data 138, environmental data 140, and data source identifiers 142. The storage media 136 can be implemented as any type of memory, random access memory (RAM), a nonvolatile memory such as flash memory, read only memory (ROM), and/or other suitable electronic data storage. The road conditions data 138 includes any type of data that may be utilized to determine a roadway condition, such as the environmental data 140, sensor data, weather forecast data, traffic data, historical data, predicted data, and/or user input data.

In an implementation, the road conditions data 138 may be obtained from a user (e.g., as user input data), such as from an operator of a vehicle 106 that provides a road conditions report via a wireless device or by user-selectable inputs on a user interface displayed in a vehicle. For example, a road conditions data system 102 that is implemented in a vehicle can include a display device to display a user interface, or can be integrated with a vehicle display. The user interface displays user-selectable inputs that a vehicle operator selects to indicate environmental, travel, and/or road conditions, such as ice, snow, poor visibility, a traffic delay, road construction, and any other type of travel and/or road condition.

The data source identifiers 142 correlate to the various roadside stations, vehicles, and/or sensors, and associate the various types of data that is collected, as well as when and where the various types of data is collected. A data source identifier 142 identifies a data source (e.g., roadside station, vehicle, reporting sign, or sensor) when registered with the road conditions data system 102. Further, a data source identifier 142 may be any one or combination of a vehicle identifier, a device identifier, an RF identifier, an IP address, and/or any other identifier that is utilized to identify a sensor, vehicle, roadside station, reporting sign, and/or road conditions data system. A data source identifier 142 can also be associated with a geographic location of a data source.

The road conditions data system 102 can be implemented in a vehicle to interrogate both a roadside station 104 and/or any of the various sensors, such as those sensors installed in the roadway or proximate the roadway. Similarly, the road conditions data system 102 can be implemented as the roadside station 104 to periodically interrogate any of the various sensors and then receive the road conditions data 138 that is sensed or otherwise detected by a sensor. Additionally, the road conditions data system 102 can be implemented as the reporting sign 108 to display a road conditions report 144 that updates in real-time (or approximate real-time) to display the road conditions data and/or a condition of the roadway 116 to warn vehicle operators of possible unsafe travel conditions. In an implementation, the reporting sign 108 includes various messages and/or warnings (e.g., a road conditions report 144) that each correspond to a determined condition of the roadway, and a message or warning is selected based on the determined condition of the roadway. For example, the road conditions data service 150 can determine the roadway condition 148, and based on the determined condition of the roadway, select to display a corresponding message or warning.

In implementations, the road conditions data system 102 can interrogate any of the various sensors at regular intervals and/or on-demand when initiated. In an embodiment, the data collection station 124 can communicate a directive to a road conditions data system (e.g., when implemented as a roadside station) to initiate that the road conditions data system 102 interrogate one or more of the various sensors. The road conditions data system 102 then receives the road conditions data 138 that is sensed or otherwise detected by a sensor, and communicates the road conditions data back to the data collection station.

The road conditions data system 102 can also include a location service 146, such as a GPS (Global Positioning System) or any other type of positioning system or geographic location system. For example, a road conditions data system 102 implemented in a vehicle may incorporate or interface with GPS in the vehicle. The location service 146 can be implemented to maintain a log of the day, time, and/or location that is associated with a travel and/or road condition. A vehicle may then report the travel and/or road condition to a passing vehicle by communicating the road conditions data 138, the environmental data 140, location service data, and/or a determined roadway condition 148 to the passing vehicle. A vehicle operator of the passing vehicle may then be warned of black ice on the roadway surface approximately two miles ahead. Not only is a vehicle operator warned of an impending unsafe travel condition, emergency responders to an accident or other emergency can be warned of the travel and/or roadway surface conditions to arrive safely at the site of an emergency.

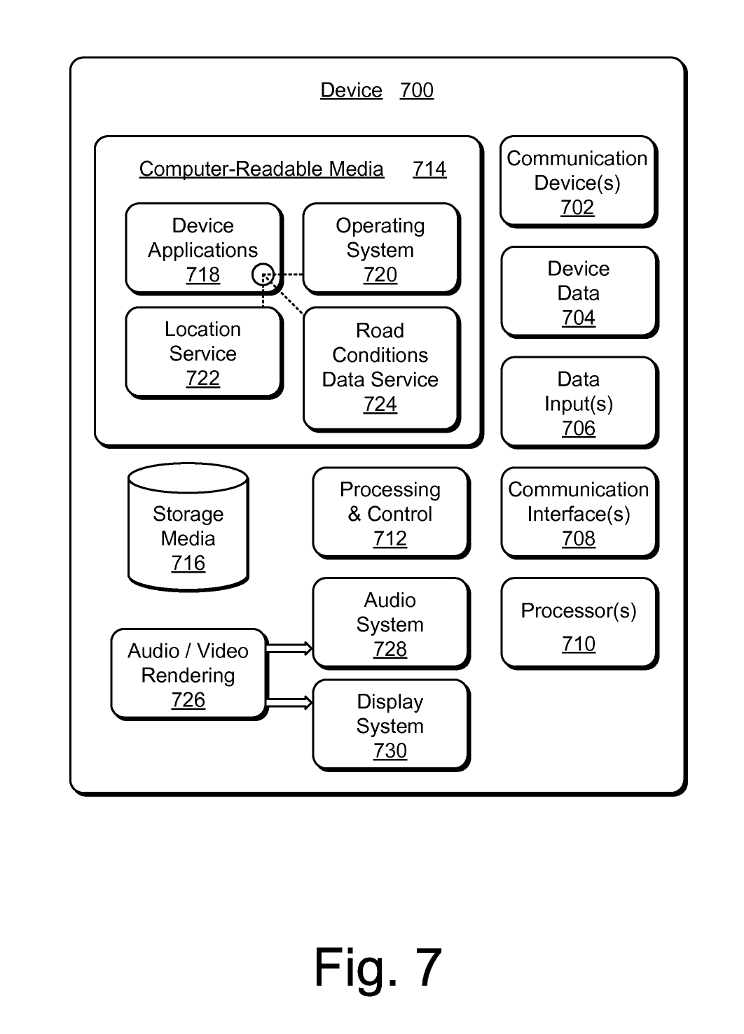

The road conditions data system 102 also includes a road conditions data service 150 that can be implemented as computer-executable instructions and executed by processors to implement the various embodiments and/or features described herein. In addition, the road conditions data system 102 can be implemented with any number and combination of differing components as further described with reference to the example device shown in FIG. 7. The road conditions data service 150, as well as other functionality described to implement embodiments of road conditions reporting, can also be provided as a service apart from the road conditions data system 102.

The road conditions data system 102 can also include any type of communication device implemented to receive and/or communicate wireless data, and may be implemented with one or more processors, communication components, memory components, signal processing and control circuits, and a device power system. For example, a road conditions data system implemented in a vehicle 106 can be powered by the vehicle, such as with a vehicle battery. A road conditions data system implemented as the roadside station 104 or as the reporting sign 108 can be powered by a battery, solar power, wind power, and/or by a wired connection to a proximate line service.

In various embodiments, the road conditions data service 150 initiates communication (e.g., transmit and/or receive) of the road conditions data 138 between any of the various roadside stations, vehicles, reporting signs, sensors, and data collection stations. The road conditions data service 150 is also implemented to determine the roadway condition 148 for a particular section of roadway surface based on the road conditions data 138. The road conditions data 138 can be collected over a duration of time, such as from the various sensors and from vehicles that pass by. The road conditions data service 150 can then initiate communication of the road conditions data 138 to the data collection station 124. In an embodiment, the road conditions data service 150 can also initiate a display of the road conditions data 138 and/or the roadway condition 148 for viewing by an operator of a vehicle traveling on the roadway, such as on a display device in the vehicle or as the road conditions report 144 on the reporting sign 108.

The environment 100 provides for high density monitoring of a roadway because roadside stations and sensors can be deployed where needed, and in addition, the vehicles are mobile and contribute to an overall view of the environment and road conditions for the roadway, or for a particular section of the roadway. For example, more roadside stations, reporting signs, and sensors may be deployed in a mountain pass where elevation, temperature, and weather conditions may change quickly and adversely affect travel conditions.

The quantity of chemicals that are applied to a roadway surface may also change extensively based on the environment and road conditions, such as through a mountain pass. Having a weather forecast along with the real-time reporting of the current conditions, and taking into account the time of day, facilitates transportation department scheduling, as well as accurate and timely application of a chemical solution to mitigate unsafe travel conditions. This can positively impact the budget that a state, county, and/or municipal transportation department allocates for inclement weather that affects road conditions. The cost of chemical solutions (e.g., deicers) and fuel for vehicles is uncertain and transportation department budgets are subject to cutbacks. A transportation department can save money and be efficient when knowing where, when, and how much chemical solution to apply. An over-application of chemical solutions, as well as the additional labor and equipment costs, can be expensive. Being able to cut even one of multiple applications of a chemical solution saves money and may lessen the effect of the chemicals on the environment.

In alternate embodiments, a road conditions data system can be deployed (e.g., as a temporary or permanent roadside station) to detect and/or collect various traffic data, such as vehicle counts to determine vehicle density at various times of a day and/or to determine vehicle weight. A road conditions data system can also be utilized to detect traffic data such as vehicle speed when sensors are positioned in or proximate a roadway to detect the time that it takes for a vehicle to travel over a distance between two sensors. In additional embodiments, a road conditions data system can be implemented to control and/or actuate other traffic control systems. For example, traffic gates that are used to close a section of a highway can receive an actuation input from a road conditions data system. Similarly, warning lights and other systems can receive an actuation input from a road conditions data system.

Additionally, a road conditions data system 102 can be implemented for surface conditions reporting to monitor, detect, or otherwise sense environmental, weather, and surface-related conditions or factors for a multitude of surfaces. For example, a surface conditions data system (e.g., an implementation of the road conditions data system 102) can be implemented for home or business use, such as to detect pavement surface conditions on a driveway that are communicated for audio or visual reporting. A surface conditions data system can also be implemented for surface conditions reporting in and/or around a warehouse, cold-storage freezer, shopping mall, airport, wharf, etc. The various surfaces that can be monitored to report surface-related conditions include, but are not limited to, runways, taxiways, parking lots, garages, boat docks, ship decks, loading docks, pathway surfaces (e.g., to include floors, paths, bike paths, walkways, sidewalks), and roadway surfaces (e.g., to include roads, overpasses, bridges, roadways, freeways, highways, and expressways).

FIG. 2 illustrates an example sensor device 200 that can be encapsulated in an electrically insulating body, support structure, encapsulant, and the like to keep the sensor environmentally and/or electrically isolated. The sensor device 200 can be implemented as any one or more of the various sensors described with reference to FIG. 1, such as sensors 110, 112, and 114 that are installed in roadway 116, sensor 118 implemented in vehicle 106, sensor 120 implemented as part of the roadside station 104, and sensor 122 that is proximate the roadside station 104. Any of the various sensors can be implemented as any one or combination of a passive, semi-passive, or active sensor. In this example, sensor device 200 includes a controller 202 that controls sensor elements 204 and operations of the sensor. The sensor device 200 also includes one or more transceivers 206 and corresponding sensor antennas 208 (e.g., directional or omni-directional antennas), as well as a passive circuit 210 and/or an active circuit 212.

The sensor elements 204 can be implemented to monitor, detect, or otherwise sense environmental, weather, and surface-related conditions or factors, such as the surface condition on a roadway, a runway, a driveway, parking lot, and/or other outdoor surfaces. The sensed conditions can be stored as sensor data (e.g., road conditions data) in a memory 214. The various sensor data can include, but is not limited to, road surface temperature, air temperature, sub-surface temperatures, humidity, barometric pressure, insolation (e.g., direct sun light), atmospheric conditions, visibility, an onset of wet, dry, or ice conditions, a cessation of wet or ice conditions, precipitation, surface moisture and conditions (e.g., ice, wet, dry, slush, ice crystals, freeze point of moisture, depth of surface moisture), the presence of a chemical solution, the chemical composition of a chemical solution that has been applied to a roadway surface, and any other environmental data and/or road conditions data. These and other sensor implementations are described with reference to U.S. Pat. No. 7,421,894.

The dew point can be approximately determined based on the sensor data (e.g., the road conditions data), such as based on the air temperature and relative humidity. A freeze point on the roadway surface can also be determined based on a combination of the road conditions data, such as based on the road surface temperature and the type and/or quantity of a chemical solution that has been applied on the roadway surface. Visibility limitations can be sensed or detected utilizing various techniques, such as a back-scatter technique with an off-axis sensor that detects reflected infra-red light when reflected by dense air, fog, heavy rain, snow, and the like. Any of the various sensor data, environmental data, road conditions data, and/or determined conditions can be communicated or otherwise reported in various embodiments of road conditions reporting.

The sensor device 200 also includes a power system 216 to power the various components of the sensor. As described with reference to FIG. 1, a passive sensor can be powered from the field of an RF signal when a transceiver of a road conditions data system (e.g., implemented as a roadside station and/or in vehicles) broadcasts a continuous wave pattern that charges the sensor. Radio frequencies that may be used include, but are not limited to, Low Frequency (LF), High Frequency (HF), and Ultra High Frequency (UHF), as well as microwave wavelengths. The power system 216 of sensor device 200 can be implemented to receive an RF signal and convert the frequency energy into usable, stored electrical energy. Power for a semi-passive sensor can be obtained passively as described above, and can also include power derived from a battery source, a wired power source, vehicle power, or alternative power sources such as solar, vibration, temperature differential, and/or wind or moving air (e.g., as a vehicle passes proximate a sensor and creates a wind effect). An active sensor can also be powered from a battery source, a wired power source, vehicle power, and/or by any of the alternative power sources.

In this example, a roadside station 218 includes a road conditions data system 220, a vehicle 222 includes a road conditions data system 224, and a reporting sign 226 includes a road conditions data system 228. Either of the road conditions data systems 220, 224, and 228 can be implemented as described with reference to the road conditions data system 102 shown in FIG. 1. The roadside station 218, vehicle 222, and/or the reporting sign 226 can interrogate the sensor device 200 while also providing power to the sensor to communicate back the sensor data. In an embodiment, the road conditions data system 220 that is implemented as the roadside station includes multiple transceivers 230 to power the sensor device 200 via more than one RF signal at 232. The road conditions data system 224 that is implemented in vehicle 222 can include multiple transceivers to power the sensor device 200 utilizing more than one RF signal at 234. Similarly, the road conditions data system 228 that is implemented as the reporting sign 226 can include multiple transceivers to power the sensor device 200 utilizing more than one RF signal at 236.

The sensor device 200 can be implemented to transmit real-time data and/or up-to-date data at preset intervals. In an implementation, the sensor device 200 can write sensor data to the nonvolatile memory 214 that is associated with the passive circuit 210 of the sensor. The passive circuit 210 can initiate a broadcast of the stored sensor data from the nonvolatile memory 214 when the power system 216 has received sufficient energy to broadcast the data. This sensor implementation may utilize one antenna for both the active and passive circuits, or may include multiple antennas that are associated with the passive circuit and/or the active circuit.

The controller 202 can implement a prescheduled interval for periodic transmission of the sensor data (e.g., road conditions data) to a road conditions data system (e.g., implemented in vehicle 222, as the roadside station 218, or as the reporting sign 226). In the event that a road conditions data system is not within range to receive the road conditions data from sensor device 200 when the sensor communicates the sensor data (e.g., at the time of the transmission), a roadside station can direct that the road conditions data be broadcast using backscatter techniques that will not drain the power system, such as a battery that powers the active circuit of the sensor. If a second antenna is utilized, the active and passive circuits of a sensor device 200 can both access the nonvolatile memory 214 which would operate as a first-in, first-out memory device.

In this example, the vehicle 222 also includes a display device 238 that can display a user interface 240. The display device 238 can be implemented as a component of the road conditions data system 224, or may be an integrated component of the vehicle that interfaces with the road conditions data system. The user interface 240 can display a road conditions report 242 that includes any type of road conditions data, environmental data, sensor data, weather forecasts, traffic data, historical data, predicted data, user input data, and the like. The user interface 240 can also display user-selectable inputs 244 that an operator of the vehicle 222 selects or interfaces with to indicate, enhance, or otherwise update the road conditions report that may then be communicated to a passing vehicle or a roadside station. The vehicle operator can select or interface with the user-selectable inputs 244 to indicate environmental, travel, and/or road conditions, such as ice, snow, poor visibility, a traffic delay, road construction, and any other type of travel and/or road condition. The road conditions data system 224 may also include an audible warning 246 that is associated with the road conditions report 242 to warn a vehicle operator of possible unsafe travel conditions.

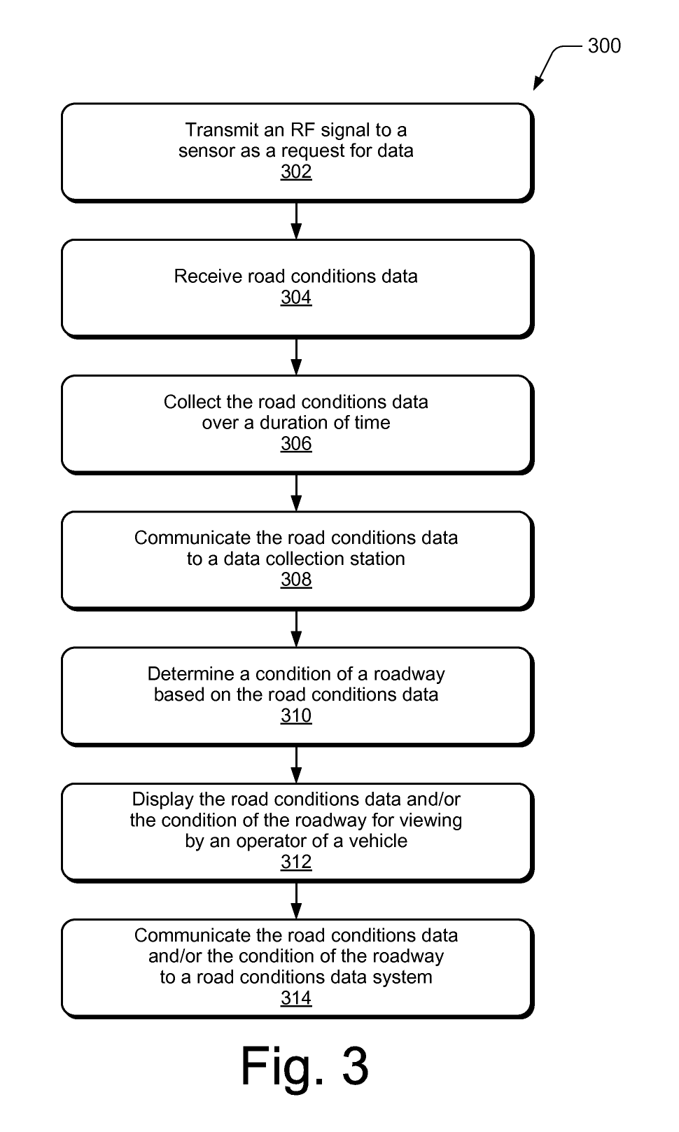

Example methods 300, 400, 500, and 600 are described with reference to respective FIGS. 3, 4, 5, and 6 in accordance with one or more embodiments of road conditions reporting. Generally, any of the functions, methods, procedures, components, and modules described herein can be implemented using hardware, software, firmware, fixed logic circuitry, manual processing, or any combination thereof. A software implementation represents program code that is executable by a computer processor. The example methods may be described in the general context of computer-executable instructions, which can include software, applications, routines, programs, components, modules, functions, and the like. The methods may also be practiced in a distributed computing environment by processing devices that are linked through a communication network. Further, the features described herein are platform-independent and can be implemented on a variety of computing platforms having a variety of processors.

FIG. 3 illustrates example method(s) 300 of road conditions reporting, and is described with reference to a road conditions data system and/or service. The order in which the method blocks are described are not intended to be construed as a limitation, and any number of the described method blocks can be combined in any order to implement a method, or an alternate method.

At block 302, an RF signal is transmitted to a sensor as a request for data. For example, a transceiver 134 (FIG. 1) of the road conditions data system 102 (e.g., implemented as the roadside station 104 and/or in a vehicle 106) interrogates a sensor 114 by transmitting an RF signal as a request for data. The sensor 114 converts the RF signal to stored energy and utilizes the stored energy to communicate the road conditions data back to the road conditions data system.

At block 304, road conditions data is received. For example, wireless interface 132 of the road conditions data system 102 receives the road conditions data 138 from any of the roadside station 104, a vehicle 106, and/or from one or more of the various sensors. The road conditions data 138 is received as any one or combination of sensor data, environmental data, weather forecast data, traffic data, or user input data.

At block 306, the road conditions data is collected over a duration of time. For example, the road conditions data system 102 implemented as the roadside station 104 collects road conditions data from the various sensors and from one or more vehicles that pass by. The road conditions data 138 is maintained and, at block 308, the road conditions data is communicated to a data collection station. For example, the road conditions data system 102 communicates the road conditions data 138 to the data collection station 124. At block 310, a condition of a roadway is determined based on the road conditions data. For example, the road conditions data service 150 of the road conditions data system 102 determines the roadway condition 148 for a particular section of roadway surface based on the road conditions data 138.

At block 312, the road conditions data and/or the condition of the roadway is displayed for viewing by an operator of a vehicle. For example, the vehicle 222 (FIG. 2) includes the display device 238 that displays the user interface 240, which displays a road conditions report 242 that includes any type of road conditions data, a condition of the roadway, environmental data, sensor data, weather forecasts, traffic data, historical data, predicted data, user input data, and the like. Alternatively or in addition, the reporting sign 108 displays a road conditions report 144 that includes the condition of the roadway and/or any type of the road conditions data for viewing by an operator of a vehicle traveling on the roadway.

At block 314, the road conditions data and/or the condition of the roadway is communicated to a road conditions data system. For example, the road conditions data system 102 implemented as the roadside station 104 communicates the road conditions data 138 and/or the roadway condition 148 to a road conditions data system implemented in a vehicle 106 traveling on the roadway. Similarly, the road conditions data system 102 implemented in a vehicle 106 communicates the road conditions data 138 and/or the roadway condition 148 to a road conditions data system that is implemented as the roadside station 104 proximate the roadway.

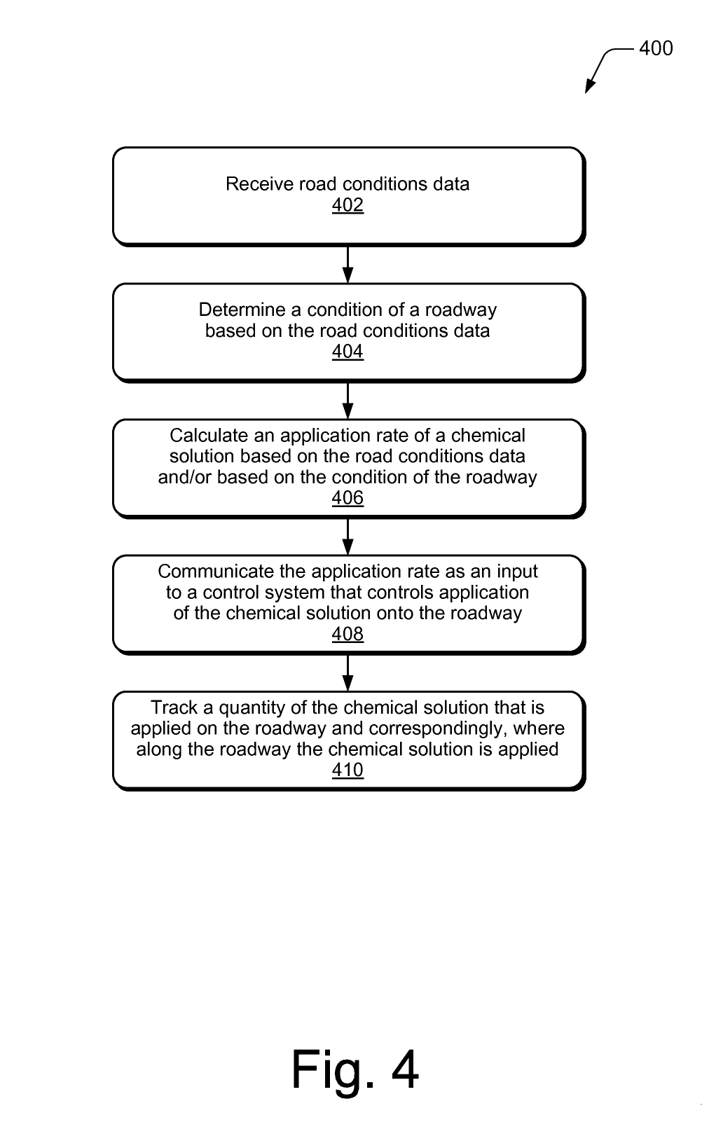

FIG. 4 illustrates example method(s) 400 of road conditions reporting, and is described with reference to a road conditions data system and/or service. The order in which the method blocks are described are not intended to be construed as a limitation, and any number of the described method blocks can be combined in any order to implement a method, or an alternate method.

At block 402, road conditions data is received. For example, wireless interface 132 (FIG. 1) of the road conditions data system 102 receives the road conditions data 138 from any of the roadside station 104, a vehicle 106, and/or from one or more of the various sensors. The road conditions data 138 is received as any one or combination of sensor data, environmental data, weather forecast data, traffic data, or user input data. In an embodiment, the road conditions data system is implemented in a vehicle, such as a transportation department vehicle that is used to disperse or apply a chemical solution onto a roadway surface.

At block 404, a condition of a roadway is determined based on the road conditions data. For example, the road conditions data service 150 of the road conditions data system 102 determines the roadway condition 148 for a particular section of roadway surface based on the road conditions data 138. At block 406, an application rate of a chemical solution is calculated based on the road conditions data and/or based on the condition of the roadway. For example, the road conditions data service 150 calculates an application rate of a chemical solution based on the road conditions data 138 and/or based on the roadway condition 148. The application rate of the chemical solution can be calculated in real-time (or approximate real-time).

At block 408, the application rate is communicated as an input to a control system that controls application of the chemical solution onto the roadway. For example, when the road conditions data system is implemented in a vehicle that is used to apply the chemical solution onto the roadway surface, the road conditions data service 150 of the road conditions data system 102 communicates an input of the application rate to a control system that controls application of the chemical solution onto the roadway. At block 410, a quantity of the chemical solution that is applied on the roadway and correspondingly, where along the roadway the chemical solution is applied is tracked. For example, the road conditions data service 150 tracks the quantity of the chemical solution that is applied and where along the roadway that it is applied (e.g., between specific mileposts and/or tracked by GPS).

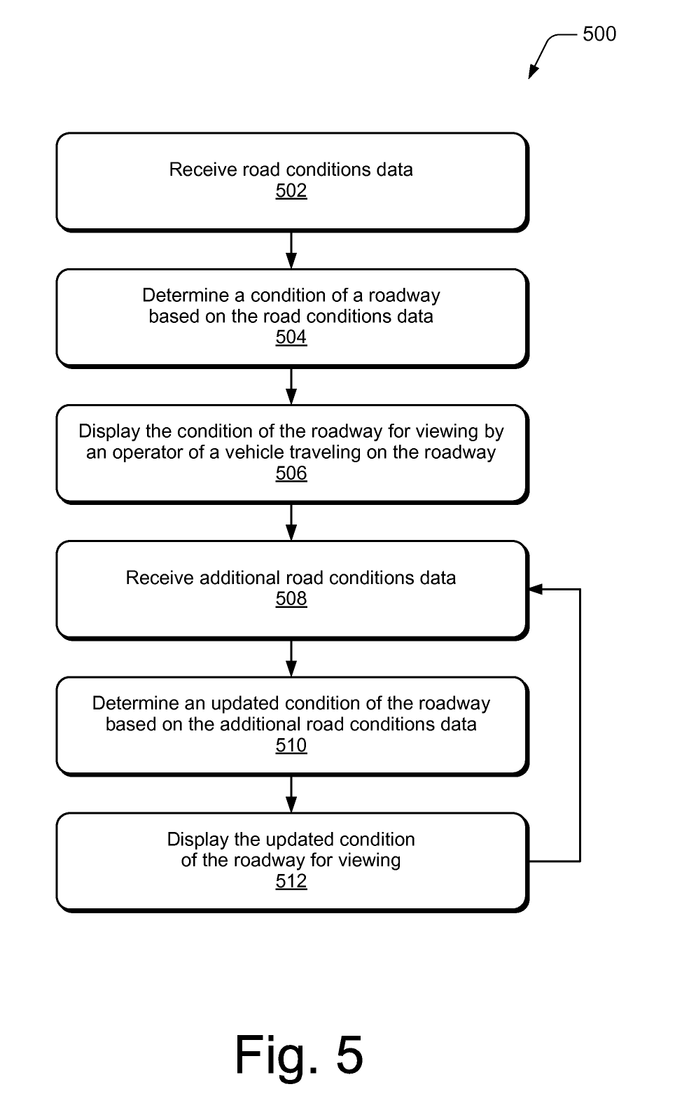

FIG. 5 illustrates example method(s) 500 of road conditions reporting, and is described with reference to a reporting sign. The order in which the method blocks are described are not intended to be construed as a limitation, and any number of the described method blocks can be combined in any order to implement a method, or an alternate method.

At block 502, road conditions data is received. For example, wireless interface 132 (FIG. 1) of the road conditions data system 102 receives the road conditions data 138 from a vehicle 106 and/or from one or more of the various sensors. The road conditions data 138 is received as any one or combination of sensor data, environmental data, weather forecast data, traffic data, or user input data. In an embodiment, the road conditions data system is implemented as reporting sign 108.

At block 504, a condition of a roadway is determined based on the road conditions data. For example, the road conditions data service 150 of the road conditions data system 102 determines the roadway condition 148 for a particular section of roadway surface based on the road conditions data 138. At block 506, the condition of the roadway is displayed for viewing by an operator of a vehicle traveling on the roadway. For example, the reporting sign 108 displays the road conditions report 144 for viewing by an operator of a vehicle 106 that passes the reporting sign when traveling on the roadway 116.

At block 508, additional road conditions data is received. For example, the road conditions data system 102 receives additional road conditions data from passing vehicles 106 and/or from one or more of the various sensors. At block 510, an updated condition of the roadway is determined based on the additional road conditions data. For example, the road conditions data service 150 of the road conditions data system 102 determines an updated roadway condition for the particular section of roadway surface based on the additional road conditions data. At block 512, the updated condition of the roadway is displayed for viewing. For example, the reporting sign 108 displays the road conditions report 144 that includes the updated roadway condition for viewing along the roadway. The method 500 can then continue to receive additional road conditions data (at block 508), determine an updated condition of the roadway (at block 510), and display the updated roadway condition (at block 512).

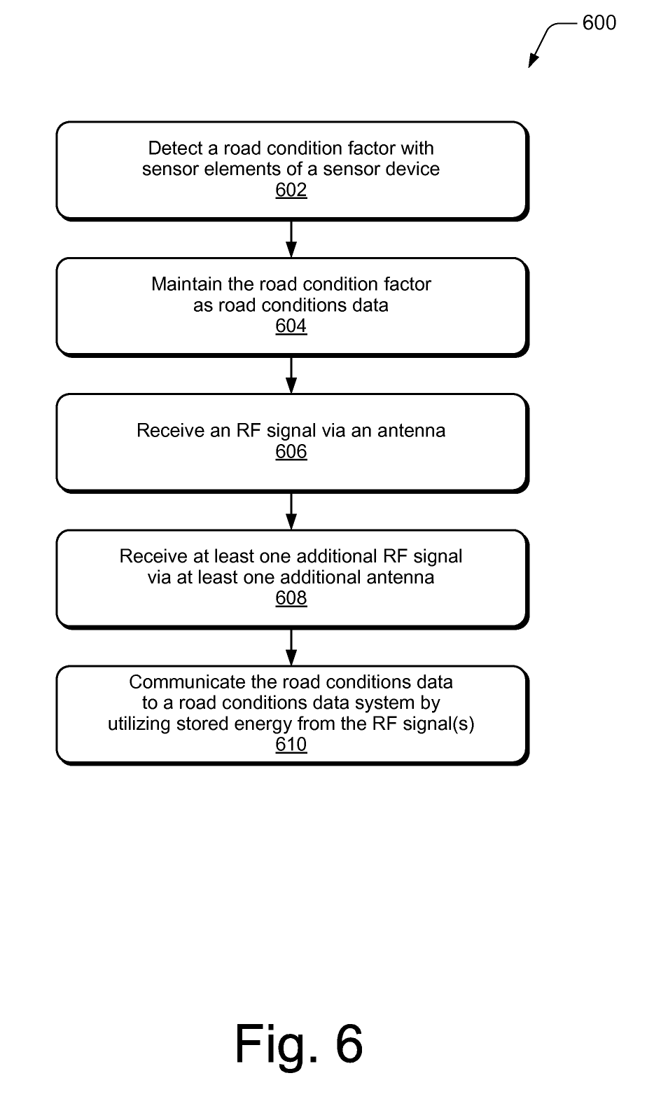

FIG. 6 illustrates example method(s) 600 of road conditions reporting, and is described with reference to a sensor device. The order in which the method blocks are described are not intended to be construed as a limitation, and any number of the described method blocks can be combined in any order to implement a method, or an alternate method.

At block 602, a road condition factor is detected with sensor elements of a sensor device. For example, the sensor elements 204 of the sensor device 200 (FIG. 2) detect a road condition factor, such as a detectable environmental condition. The sensor elements 204 detect or otherwise sense environmental and weather conditions, road condition factors, and surface-related conditions, such as the surface condition on a roadway, a runway, a driveway, parking lot, and/or other outdoor surfaces. At block 604, the road condition factor is maintained as road conditions data. For example, the memory 214 of the sensor device 200 stores or otherwise maintains the road condition factor as road conditions data (e.g., sensor data of a sensed condition or factor).

At block 606, an RF signal is received via an antenna. For example, an antenna 208 of the sensor device 200 receives an RF signal 232 and converts the RF signal into stored energy that is utilized to communicate data. In embodiments, the RF signal is received from a road conditions data system as a request for the road conditions data (e.g., the sensor data). For example, the RF signal is received from the road conditions data system 220 that is implemented as the roadside station 218, or the RF signal is received from the road conditions data system 224 that is implemented in the vehicle 222.

At block 608, at least one additional RF signal is received via at least one additional antenna. For example, an additional antenna 208 of the sensor device 200 receives an additional RF signal 232 and converts the RF signal into stored energy, at least some of which is utilized to power components of the sensor device. At block 610, the road conditions data is communicated to a road conditions data system by utilizing the stored energy from the RF signal(s). For example, a transceiver 206 of the sensor device 200 communicates (e.g., transmits) the sensor data (e.g., road conditions data) to the road conditions data system 220 that is implemented as the roadside station 218, and/or communicates the sensor data to the road conditions data system 224 that is implemented in the vehicle 222.

FIG. 7 illustrates various components of an example device 700 that can be implemented as any type of data collection station and/or a road conditions data system (e.g., implemented as a roadside station, a reporting sign, or in vehicles) as described with reference to FIGS. 1 and 2 to implement embodiments of road conditions reporting. In embodiments, device 700 can be implemented as any one or combination of a wired and/or wireless device, as any form of consumer device, computer device, server device, portable computer device, user device, communication device, appliance device, electronic device, and/or as any other type of device. Device 700 may also be associated with a user (i.e., a person) and/or an entity that operates the device such that a device describes logical devices that include users, software, firmware, and/or a combination of devices.

Device 700 includes communication devices 702 that enable wired and/or wireless communication of device data 704 (e.g., received data, data that is being received, data scheduled for broadcast, data packets of the data, etc.). The communication devices 702 can include one or more transmitters and/or transceivers to facilitate communication with passive, semi-passive, and/or active sensors. The device data 704 can include configuration settings of the device, environmental data, road conditions data, a determined roadway condition, and any other data associated with road conditions reporting. Device 700 includes one or more data inputs 706 via which any type of data, content, and/or inputs can be received, such as user-selectable inputs and sensor inputs.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of road conditions reporting. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager that includes any one or combination of a control application, software application, signal processing and control module, code that is native to a particular device, and/or a hardware abstraction layer for the particular device.

The device applications 718 also include any system components or modules to implement embodiments of road conditions reporting. In this example, the device applications 718 include a location service 722 and a road conditions data service 724 when device 700 is implemented as a road conditions data system (e.g., in a vehicle, or as a roadside station). The location service 722 and the road conditions data service 724 are shown as software modules and/or computer applications. Alternatively or in addition, the location service 722 and/or the road conditions data service 724 can be implemented as hardware, software, firmware, circuitry, or any combination thereof.

Device 700 also includes an audio and/or video rendering system 726 that generates and provides audio data to an audio system 728 and/or generates and provides display data to a display system 730. The audio system 728 and/or the display system 730 can include any devices that process, display, and/or otherwise render audio, display, and image data. Display data and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

Device 700 can also include an integrated display and/or an integrated touch-screen, as well as selectable input controls via which a user inputs data and/or selections. For example, a navigation display in a vehicle may include an integrated touch-screen on which a user interface can be displayed that includes displayable objects and/or user interface elements, such as any type of an icon, image, graphic, text, selectable button, user-selectable control, menu selection, map element, and/or any other type of user interface displayable feature or item.

Although embodiments of road conditions reporting have been described in language specific to features and/or methods, it is to be understood that the subject of the appended claims is not necessarily limited to the specific features or methods described. Rather, the specific features and methods are disclosed as example implementations of road conditions reporting.

1. A road conditions data system, comprising:
a communication interface configured to receive road conditions data from which a condition of a roadway can be determined;
at least a memory and a processor that implement a road conditions data service configured to:
determine the condition of the roadway based on the road conditions data; and
initiate communication of at least one of the road conditions data or the condition of the roadway to an additional road conditions data system.

2. A road conditions data system as recited in claim 1, wherein the road conditions data is at least one of sensor data, environmental data, weather forecast data, traffic data, or user input data.

3. A road conditions data system as recited in claim 1, wherein the communication interface is further configured to receive the road conditions data from at least one of a roadside station, a vehicle, or a sensor.

4. A road conditions data system as recited in claim 1, wherein the road conditions data service is further configured to initiate a display of at least one of the road conditions data or the condition of the roadway for viewing by an operator of a vehicle traveling on the roadway.

5. A road conditions data system as recited in claim 1, further comprising a display device when the road conditions data system is implemented as a reporting sign positioned proximate the roadway and configured to display the condition of the roadway.

6. A road conditions data system as recited in claim 1, further comprising a transmitting device configured to transmit an RF signal as a request to a sensor that converts the RF signal into stored energy and utilizes the stored energy to communicate the road conditions data that is received at the communication interface.

7. A road conditions data system as recited in claim 1, wherein the additional road conditions data system is implemented in a vehicle traveling on the roadway, and wherein the condition of the roadway is communicated to the vehicle while the vehicle is traveling on the roadway.

8. A road conditions data system as recited in claim 1, wherein the additional road conditions data system is implemented as a roadside station proximate the roadway, and wherein the road conditions data is communicated to the roadside station from a vehicle traveling on the roadway.

9. A road conditions data system as recited in claim 1, wherein the road conditions data service is further configured to:
calculate an application rate of a chemical solution based on the road conditions data; and
track a quantity of the chemical solution that is applied on the roadway and where along the roadway the chemical solution is applied.

10. A computer-implemented method, comprising:
receiving road conditions data from which a condition of a roadway can be determined;
determining the condition of the roadway based on the road conditions data; and
communicating at least one of the road conditions data or the condition of the roadway to a road conditions data system.

11. A computer-implemented method as recited in claim 10, further comprising:
collecting the road conditions data over a duration of time; and
communicating the road conditions data to a data collection station.

12. A computer-implemented method as recited in claim 10, further comprising transmitting an RF signal as a request to a sensor that converts the RF signal into stored energy and utilizes the stored energy to communicate the road conditions data that is received.

13. A computer-implemented method as recited in claim 10, wherein the condition of the roadway is communicated to the road conditions data system that is implemented in a vehicle traveling on the roadway.

14. A computer-implemented method as recited in claim 10, further comprising displaying at least one of the road conditions data or the condition of the roadway for viewing by an operator of a vehicle traveling on the roadway.

15. A computer-implemented method as recited in claim 10, further comprising:
displaying the condition of the roadway for viewing by an operator of a vehicle traveling on the roadway;
receiving additional road conditions data;
determining an updated condition of the roadway based on the additional road conditions data; and
displaying the updated condition of the roadway for viewing.

16. A computer-implemented method as recited in claim 10, further comprising displaying the condition of the roadway on a reporting sign that is proximate the roadway.

17. A computer-implemented method as recited in claim 10, further comprising:
calculating an application rate of a chemical solution based on the road conditions data;
communicating the application rate as an input to a control system that controls application of the chemical solution onto the roadway; and
tracking a quantity of the chemical solution that is applied on the roadway and where along the roadway the chemical solution is applied.

18. A vehicle, comprising:
a road conditions data service configured to determine a condition of a roadway from road conditions data;
a road conditions data system configured to:
receive the road conditions data as sensor data from one or more sensors proximate a surface of the roadway; and
communicate at least one of the road conditions data or the condition of the roadway to another vehicle.

19. A vehicle as recited in claim 18, wherein the road conditions data system is further configured to receive additional road conditions data from at least one of a roadside station or an additional vehicle.

20. A vehicle as recited in claim 18, wherein the road conditions data system is further configured to collect the road conditions data over a duration of roadway travel, and communicate the road conditions data to a data collection station.

21. A vehicle as recited in claim 18, wherein the road conditions data system is further configured to communicate the road conditions data to an additional vehicle traveling the roadway.

22. A vehicle as recited in claim 18, wherein the road conditions data service is further configured to initiate a display of at least one of the road conditions data or the condition of the roadway for viewing by an operator of the vehicle traveling on the roadway.

23. A vehicle as recited in claim 18, further comprising a chemical solution application system configured to disperse a chemical solution onto the roadway, and wherein the road conditions data service is further configured to:
calculate an application rate of the chemical solution based on the road conditions data;
communicate the application rate as an input to a control system of the chemical solution application system; and
track a quantity of the chemical solution that is applied on the roadway and where along the roadway the chemical solution is applied.

24. A reporting sign, comprising:
a road conditions data service configured to determine a condition of a roadway from road conditions data;
a road conditions data system configured to:
receive the road conditions data as sensor data from one or more sensors proximate a surface of the roadway; and
display the condition of the roadway for viewing by an operator of a vehicle traveling on the roadway.

25. A reporting sign as recited in claim 24, wherein:
the road conditions data service is further configured to determine an updated condition of the roadway from additional road conditions data; and
the road conditions data system is further configured to display the updated condition of the roadway for viewing.

26. A sensor device, comprising:
one or more sensor elements configured to detect a road condition factor;
a memory configured to maintain the road condition factor as road conditions data;
an antenna configured to receive an RF signal that is converted into stored energy; and
a transmitting device configured to utilize at least some of the stored energy to communicate the road conditions data to a road conditions data system.

27. A sensor device as recited in claim 26, wherein the road condition factor is a detectable environmental condition.

28. A sensor device as recited in claim 26, further comprising at least one additional antenna configured to receive at least one additional RF signal that is converted into the stored energy, and wherein components of the sensor device are powered by at least some of the stored energy.

29. A sensor device as recited in claim 26, wherein the RF signal is received from the road conditions data system as a request for the road conditions data.

30. A sensor device as recited in claim 26, wherein the RF signal is received from the road conditions data system that is implemented in a vehicle, which receives the road conditions data from the sensor device.

31. A sensor device as recited in claim 26, wherein the RF signal is received from the road conditions data system that is implemented as a roadside station, which receives the road conditions data from the sensor device.

32. A method, comprising:
detecting a road condition factor with sensor elements of a sensor device;
maintaining the road condition factor as road conditions data;
receiving an RF signal via an antenna, the RF signal being converted into stored energy that is utilized to communicate data; and
communicating the road conditions data to a road conditions data system by utilizing at least some of the stored energy.

33. A method as recited in claim 32, wherein the road condition factor is a detectable environmental condition.

34. A method as recited in claim 32, further comprising receiving at least one additional RF signal via at least one additional antenna, the at least one additional RF signal being converted into the stored energy, and wherein components of the sensor device are powered by at least some of the stored energy.

35. A method as recited in claim 32, wherein the RF signal is received from the road conditions data system as a request for the road conditions data.

36. A method as recited in claim 32, wherein the RF signal is received from the road conditions data system that is at least one of implemented in a vehicle, as a roadside station, or as a reporting sign.
